(19) United States
(12) Patent Application Publication
(10) Pub. No.: US 2025/0146518 A1
(43) Pub. Date: May 8, 2025

(54) SNAP-ON FURNITURE SYSTEM

(71) Applicant: Galstaun Holding B.V., Vught (NL)

(72) Inventors: Peter Alexander Antonius van de Hoef, Vught (NL); Rik Wouters, Vught (NL); Bart Jan André Poort, Vught (NL); Freddy Eugene Abraham Galstaun, Vught (NL)

(21) Appl. No.: 19/018,153

(22) Filed: Jan. 13, 2025

Related U.S. Application Data
(63) Continuation-in-part of application No. PCT/EP2023/069504, filed on Jul. 13, 2023.

(30) Foreign Application Priority Data
Jul. 14, 2022 (NL) 2032485

(51) Int. Cl. F16B 13/04; F16B 12/10

(52) U.S. Cl. CPC F16B 13/04; F16B 2012/103

(57) ABSTRACT

A furniture panel joining system includes a joint piece for connecting a furniture panel. The joint piece has a base body having a male connector to be inserted into T-slot of a furniture panel. The joint piece has a top portion provided with at least one female connector. The female connector is configured for receiving a male member formed by a pin head of a couple item. The couple item is of benefit for attaching a furniture item which in particular includes a wired electronic unit in a quick manner without a need for a tool or glue to the furniture panel.

### CROSS-REFERENCE TO RELATED APPLICATIONS

This application is a Continuation-in-Part of National Stage of International Application No. PCT/EP2023/069504, filed Jul. 13, 2023, which claims the benefit of Netherlands Application No. 2032485, filed Jul. 14, 2022, the contents of which is incorporated by reference herein.

### FIELD OF THE INVENTION

The invention relates to a method and a furniture panel joining system for joining adjacently positioned furniture panels, wherein the furniture panel joining system comprises a joint piece and a furniture panel. The joint piece is arranged for connecting a furniture panel and comprises a base body having at least one end face provided with at least a male connector for connecting a furniture panel. The male connector is formed by an insert element including a head portion. The furniture panel is provided with a T-slot for receiving the male connector of the joint piece to connect the furniture panel.

### BACKGROUND OF THE INVENTION

U.S. Pat. No. 325,696 published in 1885 discloses a joint piece for connecting a shelf to a side. The joint piece is right-angled including knobs upon its top and end. The shelf and side are provided with elongated undercut recesses, key hole slots, having an enlargement at one end for the insertion of a knob. After an insertion of a knob in the keyhole slot, the joint piece is shifted to fasten the joint piece to either the shelf or side.

WO 2018/094281 published in 2018 discloses a similar joint piece for interconnecting furniture panels which are each provided with a keyhole slot. The joint piece has a base body having a bottom surface which is provided with a male connector formed by an insert element including a head portion. The head portion which is designed to be received in the keyhole slot has guide ramps to enhance the insertion.

WO 2021/245591 published in 2021 discloses another connecting system between components of a piece of furniture. The connection system has a joint piece which comprises a male connector formed by a pin having a base with a stem and an enlarged portion to be inserted into a keyhole slot. An anti-sliding device is configured to prevent a sliding of the pin inside the keyhole slot when the pin is in a tightening position.

US 2017/0023043 A1 discloses a channel lock shelf fastener which is used in conjunction with a barbed channel lock to create a joint. The channel lock shelf fastener works with partitions and end panels with standard 5 mm diameter line bores. A barbed post can be inserted straight into the 5 mm diameter bore in the partition or end panel.

A challenge in designing such furniture connecting systems is to provide a system which simplifies a mounting of a furniture without necessitating a tool and which at the same time provides a tight and robust connection. A drawback of many known furniture connecting systems is that too much operational steps are still necessary to provide the connection.

Regarding mentioned prior art, it is remarked that any discussion of documents, acts, materials, devices, articles or the like included in the present specification is for the purpose of providing a context for the present invention, and is not to be taken as an admission that any such matters form part of the prior art or were before the priority date of each claim of this application common general knowledge in the field relevant to the present invention.

### OBJECT AND SUMMARY OF THE INVENTION

The general object of the present invention is to at least partially eliminate the above mentioned drawback and/or to provide a usable alternative. More specific, it is an object of the invention to provide a furniture panel joining system including components having a simple configuration to establish a robust quick connection in a simple manner without a need for a tool.

This object is achieved by a furniture panel joining system according to according to the invention. The furniture panel joining system is arranged to join furniture panels. In particular to join adjacently positioned furniture panels. The furniture panels may be positioned side-by-side in a common plane, inclined positioned with respect to each other, or being spaced in parallel with to each other.

The furniture panel joining system comprises a joint piece. The joint piece is arranged to join the furniture panels. The joint piece has a base body which has at least one end face which is provided with at least one male connector. The base portion is configured to be connected to a furniture panel. The male connector may be formed by an insert element which includes a stem portion and a head portion. The head portion forms an enlargement on top of the stem portion for connecting the male connector in a T-slot. Alternatively, the male connector may be formed by an insert element including a threaded portion for connecting the male connector in a thread hole.

In particular, the joint piece further comprises a second male connector for interconnecting an adjacently positioned furniture panel. The second male connector may be positioned aside the first male connector at the same end face for joining side by side positioned furniture panels. The second male connector may be elongated and preferably extends in parallel with the first male connector. The second male connector may be positioned at another end face of the base body which end face is inclined with respect to the end face comprising the first male connector for interconnecting angled positioned furniture panels.

The furniture panel joining system is configured to receive the at least one male connector of the joint piece and may comprises a furniture panel which is provided with a T-slot or a thread hole for receiving the male connector of the joint piece.

In particular, the furniture panel joining system comprises a first and a second furniture panel which are each provided with a T-slot for receiving respectively the first and second male connector of the joint piece. After shifting the first and second male connector of the joint piece into the T-slots, the connection of the first furniture panel to the second furniture panel is obtained. Herewith, the furniture panel joining system is suitable for quickly building a modular assembly, like a wall system or a cabin out of interconnected furniture panels.

The furniture panel joining system according to the invention is improved in that the furniture panel joining system further comprises a couple item. The couple item is arranged to couple a furniture item to the joint piece in a quick manner.

To establish the quick connection of the furniture item, the base body of the joint piece has a top portion which is provided with at least one female connector. The couple item has a male member which is complementary shaped to the female connector of the joint piece. The female connector of the joint piece is formed by an aperture, in particular a through hole, for receiving this male member of the couple item. The male member to be received by the at least one female connector is formed by a pin element which has a pin head being connectable to the female connector of the joint piece. Preferably, the pin head has a conical shape for centring the pin element with respect to the female connector of the joint piece when inserting the couple item into the female connector.

The cylindrical pin-shape of the couple item is beneficial in that it allows a quick connection by insertion of the couple item into one of the female connectors of the joint piece. A female connector provided at the joint piece is advantageous in building a modular assembly. The female connector will then be arranged stationary before receiving the male connector. The male connector will be attached by making an insertion motion to connect the male member to the female connector. Particularly, the insertion motion is directed towards the end face of the base body. Instead of an inverse arrangement, the featuring of a stationary female connector and a stinging male member contributes to a positional accurate and quick attachment of the furniture item.

The couple item may be a separate item, e.g. a removable pin element having a foot portion for attachment to a furniture item, or the couple item may be incorporated in the furniture item. The couple item may be integrally shaped with the furniture item, e.g. by injection moulding.

In an embodiment of the furniture panel joining system, the couple item has a pin head which is formed by a snap-on member to be snapped into the aperture of the female connector of the joint piece. Typically, the snap-on member has at least one snap finger which is resilient to attach the couple item to the joint piece. By snapping the couple item into the aperture of the female connector, the furniture item is advantageously coupled to the joint piece in a quick manner.

In an embodiment of the furniture panel joining system, the couple item has a foot portion which is connectable to a T-slot of the furniture item. In particular, the furniture item is provided with a keyhole slot for receiving the foot portion. Preferably, the foot portion is sized in correspondence with the male connector of the joint piece. The same size of T-slots in both the furniture panels and in the furniture item is provided. A same dimensioning of a T-slot in a furniture panel and in a furniture item is beneficial in manufacturing the furniture panel joining system.

In an embodiment of the furniture panel joining system, the couple item has a threaded foot portion being screwable into a thread hole of a furniture item.

In an embodiment of the furniture panel joining system, the couple item may be incorporated in the furniture item. The couple item may be integrally formed with the furniture item. The furniture item may for example comprise a plastic base portion including moulded couple items.

In an embodiment of the furniture panel joining system, the base body of the joint piece has a single end face provided with at least a first and second male connector for interconnecting side by side positioned furniture panels. In particular, each male connector has an elongated shape, wherein the first and second male connectors are arranged in parallel.

In another embodiment of the furniture panel joining system, the base body of the joint piece has a first end face provided with the first male connector and a second end face provided with the second male connector. The first end face is inclined with respect to the second end face. Angled positioned furniture panels can be interconnected by this joint piece. Preferably, the first end face is oriented in perpendicular to the second end face to mount a first furniture panel being positioned in perpendicular to a second furniture panel.

In an embodiment of the furniture panel joining system, the base body of the joint piece has a truncated shape. The truncated shape of the base body may be formed by crossing plate shaped bodies. The base body has a top portion being smaller than a lower portion of the base body.

In an embodiment of the furniture panel joining system, the top portion of the base body includes a first and a second female connector. Preferably, the top portion further comprises a third and fourth female connector.

In an embodiment of the furniture panel joining system, the T-slot of at least one of the first and second furniture panels may extend from a panel edge across a panel surface. At the panel edge surface, the T-slot may be open to form an entry hole for receiving the head portion of the male connector. Preferably, the T-slot is formed by a keyhole slot. The keyhole slot is an undercut recess which has an entry hole being spaced apart from the panel edge. The spaced keyhole slot reduces a risk on damages to the panel edge and contributes to a robustness of the connection to be made.

In an embodiment of the furniture panel joining system, the furniture item comprises an inner furniture panel. The furniture item may be a cover plate for finishing a wall provided by furniture panels being interconnected by a joint piece of the furniture panel joining system.

In an embodiment of the furniture item, the inner furniture panel has a rectangular shape, wherein each corner is provided with a keyhole slot. Preferably, each keyhole slot is diagonally directed. Each keyhole slot has an entry hole for receiving a foot portion of the couple item. Preferably, the entry hole is positioned at an end of the keyhole slot away from a corner of the inner furniture panel.

In another embodiment, the furniture item may comprise an electronic unit mounted to the inner furniture panel. The electronic unit may be an actuator, e.g. scent dispenser, a speaker, microphone, a sensor et cetera. Typically, the electronic unit is provided with an electric wire, e.g. a power supply or signal wire. The furniture item including the electronic unit and the inner furniture panel is beneficial in that the inner furniture panel may form a base to attach the furniture item to the top portion of the joint piece. Any wire of the electronic unit can extend behind the inner furniture panel in an inner space formed by the spaced inner furniture panel relative to the furniture panels interconnected by the joint piece. A height of the base body of the joint piece determines a height of the inner space being available to get rid of any wires.

Further, the invention relates to a wall system for forming a wall by interconnecting furniture panels. More in particular, the invention relates to a cabin system including at least one wall mountable by interconnecting furniture panels. Such a cabin system may for example be arranged to build a sauna cabin. The sauna cabin may comprise at least one wall being provided with at least one electronic unit.

In an embodiment of the wall system, the wall system comprises a double wall formed by an outer wall of interconnected furniture panels and an inner wall formed by inner furniture panels being spaced from the furniture panels by joint pieces. Beneficially, the double wall of the wall system has an inner space which is suitable for hiding electric wires.

In an embodiment of the furniture panel joining system, a set of furniture items may be provided, wherein each furniture item may have the same base formed by the inner furniture panel. The set of furniture items forms a modular set which allows a user to build a wall or cabin provided with a selection of these furniture items. Herewith, the furniture panel joining system may form a modular wall system, in particular a modular cabin system.

The modular cabin system may for example be used to build a sauna including at least one electronic unit being mounted to an inner furniture panel which is attachable to a top portion of a joint piece which interconnects furniture panels.

In an embodiment, the furniture panel joining system may be part of a wall system, in particular a cabin system. The system comprises the furniture panel joining system for joining adjacently positioned furniture panels. The joint furniture panels may form a side wall of the cabin.

In an embodiment of the cabin system, the side wall of the cabin formed by furniture panels is formed in a modular manner. The side wall includes a regular pattern of T-slots for attaching joint pieces. Each joint piece has a top portion with a female connector which provides a connection point to connect a furniture item by a couple item.

Further, the invention relates to a method for connecting a joint piece to a furniture panel. In particular, the invention relates to a method for interconnecting a first furniture panel and a second furniture panel. More in particular, the invention relates to a method for connecting a furniture item to at least one furniture panel, in particular to an interconnected first and second furniture panel. In a step of the method, a furniture panel joining system according to the invention is provided which includes a joint piece and a furniture panel, in particular a first and second furniture panel, more in particular a furniture item. In a step of the method, the joint piece is connected to the first furniture panel by inserting a male connector of the joint piece into a T-slot of the first furniture panel. In a step of the method, at least one couple item is provided for attaching the furniture item to the furniture panel. The at least one couple item may be connected, connectable or integral with the furniture item. In a step of the method, the furniture item is connected to the furniture panel by inserting a pin head of the at least one couple item into a female connector of the joint piece.

In an embodiment of the method according to the invention, the at least one couple item is a separate item, wherein in a step of the method, the couple item is attached to the furniture item, in particular by inserting and shifting of foot portion of the couple item into a T-slot of the furniture item.

The invention will be explained in more detail with reference to the appended drawings. The drawings show a practical embodiment according to the invention, which may not be interpreted as limiting the scope of the invention. Specific features may also be considered apart from the shown embodiment and may be taken into account in a broader context as a delimiting feature, not only for the shown embodiment but as a common feature for all embodiments falling within the scope of the appended claims.

### BRIEF DESCRIPTION OF THE DRAWINGS

FIG. 1 shows a perspective view of a preferred embodiment of a furniture panel joining system according to the invention having two furniture panels being interconnected by a joint piece;

FIG. 2 shows a furniture item having a keyhole slot at a corner position being arranged for an attachment of a couple item to couple the furniture item to the joint piece of the furniture panel joining system as shown in FIG. 1;

FIG. 3 shows the joint piece and a complementary couple item in an exploded view in which the couple item has a pin head which can be snapped into a female connector of the joint piece;

FIG. 4 shows three couple items snapped into female connectors of the joint piece;

FIG. 5 shows a couple item formed by a pin element attached to the furniture item as shown in FIG. 2;

FIG. 6 shows another embodiment of a joint piece of the furniture panel joining system being arranged for interconnecting right angled positioned furniture panels;

FIG. 7 shows a cabin system which is built by the furniture panel joining system;

FIG. 8 shows a double-walled system formed by the furniture panel system according to the invention;

FIGS. 9 and 10 show each an enlarged view of a corner section of the double-walled system having an inner wall connected to an outer wall formed by a first and second furniture panel;

FIG. 11 shows a perspective view of another embodiment of the furniture panel joining system in which a joint piece and a couple item is screw mounted;

FIG. 12 shows a screw tool for mounting the joint piece to a furniture panel; and

FIG. 13 shows the same screw tool engageable to the couple item of the furniture panel joining system for mounting the couple item to a furniture item.

### DETAILED DESCRIPTION OF THE INVENTION

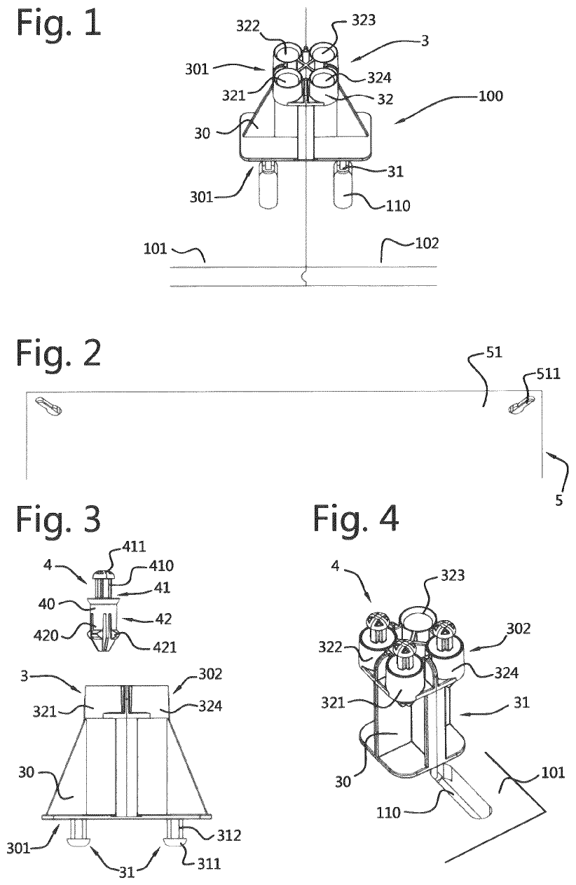

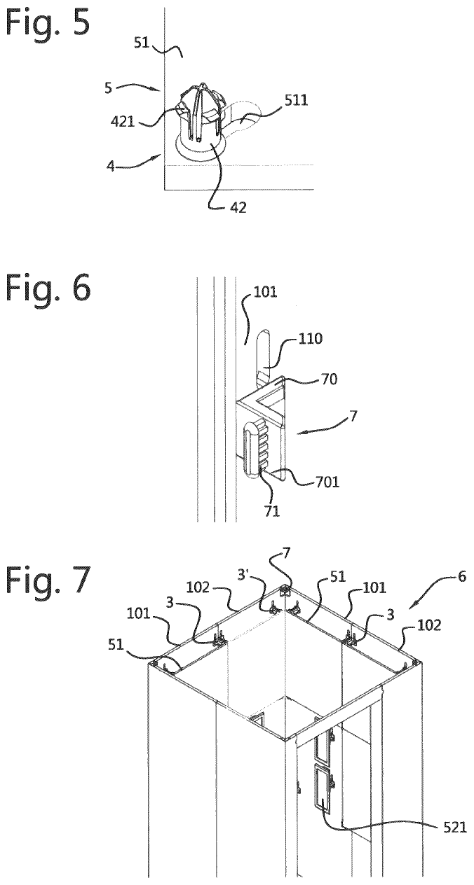

In FIGS. 1-13, a furniture panel joining system according to the invention is denoted overall by reference numeral 100. Identical reference signs are used in the drawings to indicate identical or functionally similar components. To facilitate comprehension of the description and of the claims the words vertical, horizontal, longitudinal, cross-sectional and a coordinate system X, Y, Z shown in the drawings—with reference to a common placement of the furniture panel joining system forming a side wall—are used in a non-limiting way.

FIG. 1 shows a perspective view of a furniture panel joining system 100 in an embodiment according to the invention. The furniture panel joining system 100 has a first furniture panel 101 which is connectable to a second furniture panel 102 by a joint piece 3.

The joint piece 3 is configured to join adjacent positioned furniture panels. The joint piece 3 has a base body 30. Here, the base body 30 has an end face 301 which is provided with a first and second male connector 31 for interconnecting the furniture panels 101, 102. Each male connector 31 is formed by an insert element 310 which has a stem portion 312 and a head portion 311. The head portion 311 forms an enlargement on top of the stem portion 312. Preferably, the insert element has an oblong shape.

As shown, here, the first and second furniture panels 101, 102 are abutting co-planarily against each other. The first and second furniture panels are positioned in a flush manner. Each furniture panel is provided with a T-slot 110. The T-slot extends along an edge of the furniture panel. Here, the T-slot is formed by a keyhole slot 111 which is positioned at a distance from a furniture panel edge. The keyhole slot is formed by an undercut recess and an entry hole. Here, the entry hole is elongated. The elongated entry hole provides an entrance for the male connector 31 of the joint piece 3. After receiving the male connectors 31 into the T-slots 110 and a sliding motion shifting the head portion 311 of the male connectors into the undercut recess, the first and second furniture panels 101, 102 are interconnected by the joint piece 3.

FIG. 2 shows a furniture item 5 which is connectable to a top portion 302 of the joint piece 3 by a couple item 4. The furniture item 5 includes an inner furniture panel 51. The inner furniture panel 51 may be a cover panel for covering an inner side of a wall built by interconnected furniture panels. The inner furniture panel 51 is joined by the joint piece to the interconnected first and second furniture panels 101, 102. The inner furniture panel 51 may form an attachment base of an electronic unit. The inner furniture panel 51 may for example hold an electronic component, like an actuator, dispenser or sensor.

The furniture item 5 has a rectangular shape. At each corner, the furniture item 5 is provided with a keyhole slot 511. Each keyhole slot 511 is diagonally oriented. Each keyhole slot 511 has an entry hole positioned away from the corner. Each keyhole slot 511 provides a position for fastening the couple item 4.

As shown in FIGS. 3 and 4, the couple item 4 is formed by a pin element 40. The pin clement is cylindrical and pin shaped. The pin element 40 has a foot portion 41 which is configured to fit into the keyhole slot 511 of the furniture item 5. The foot portion is formed by a foot stem 410 and a foot base 411. Preferably, the foot portion 41 is equally sized as the male connector 31 of the joint piece 3, such that all T-slots of the furniture panel joining system 100 can be equally manufactured.

The pin element 40 has a pin head 42 which is couplable to a female connector 32 provided at the top portion 302 of the joint piece 3. The female connector 32 is formed by an aperture 320 which is here formed by a through hole. Here in FIG. 3, as also shown in FIG. 1, four female connectors are provided. The top portion 302 includes a first, second, third and fourth female connector 321, 322, 323, 324. The pin head is insertable into one of the female connectors by an insertion motion which is directed to the end face 301. The pin head 42 is provided with a snap-on member 420. Typically, the snap-on number 420 comprises at least one snap finger 421. The snap-on member 420 is configured to snap into a female connector 32 of the joint piece. By snapping the couple item 4 to the joint piece 3, a quick connection can be established in between the furniture item 5 and a furniture panel 101. It is an advantage that the joint being formed by the joint pieces 3 and couple items 4 may be completely invisible after making the connection which renders the furniture panel joining system according to the invention of particular value in making furniture which can be easily manually assembled without requiring a tool or glue and wherein the joints formed by the joint pieces are invisible.

As further shown in FIGS. 7-10, after the connection, an inner space is obtained in between the furniture item 5 and the furniture panels 101, 102. Preferably, the furniture item 5 has a closed inner furniture panel to close off the inner space. The base body 30 of the joint piece 3 spaces the inner furniture panel 51 at a distance from the furniture panel 101. A double-walled system can be formed by the furniture panel joining system 100. Beneficially, the inner space of the double-walled system may serve for guiding electric wires or as a space for ventilation. The double-walled system can be used for building a wall or cabin. The wall or cabin can be formed in a modular manner. Equally sized furniture panels 101, 102 can be used to build an outer wall, wherein a plurality of inner furniture panels 51 can be coupled to present joint pieces to build an inner wall.

As shown in FIG. 4, in an embodiment, the joint piece 3 has a base body 30 having an end face 301 which is provided with only a single male connector 31 to attach the joint piece 3 to a furniture panel 101. Here, the joint piece 3 is suitable to join an inner furniture panel 51 to the furniture panel 101. The inner furniture panel 51 extends in parallel with the furniture panel 101.

FIG. 6 shows an embodiment of a corner joint 7. Here, the corner joint 7 is an angle joint piece for interconnecting angled positioned furniture panels. The corner joint 7 has a male connector 71 at a corner joint end face 701 of a corner joint body 70. This corner joint 7 is suitable for interconnecting a first outer side wall to a second outer side wall being positioned in perpendicular to each other for forming a cabin. Preferably, the corner joint 7 is formed as a joint piece 3 having a base body 30 with a rectangular shape in cross section, wherein an end face opposite the corner joint end face 71 provided with at least one male connector is provided with at least one female connector 32 for coupling a couple item 4.

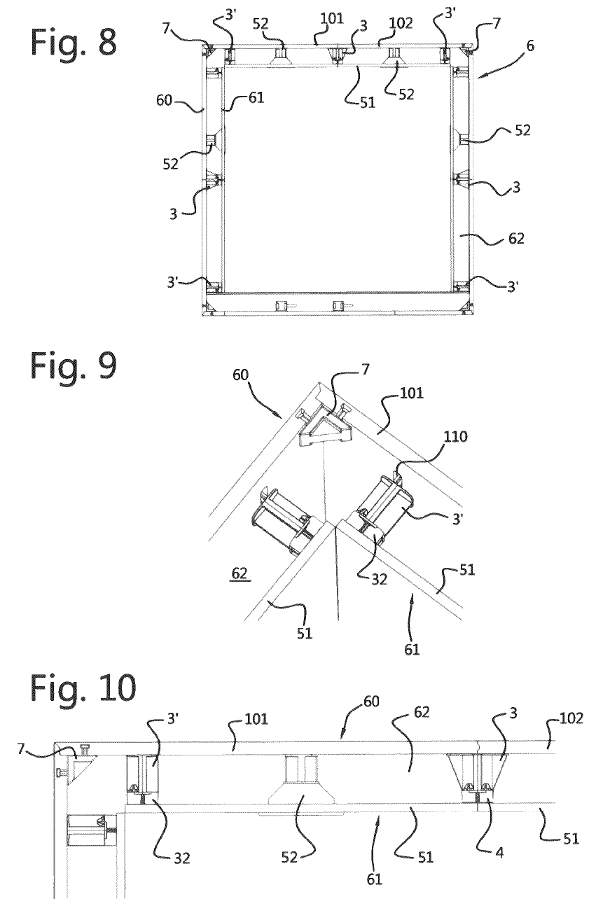

FIG. 7 shows a cabin 6, in particular a sauna cabin, being built by a double-walled system. FIG. 8 shows a cross-sectional view of the double-walled system including the furniture panel joining system 100.

As further shown in detail in FIGS. 9 and 10, the cabin 6 has an outer wall 60 formed by interconnected furniture panels 101, 102 and an inner wall 61 formed by furniture panels 51. An inner space 62 is situated in between the inner and outer wall 60, 61. The inner space 62 is suitable for housing an electronic unit 52, like a sensor, a lamp, an actuator, a dispenser or a speaker. The inner space 62 is suitable for guiding an electric wire of an electronic unit 52 to a control unit. Here, at each corner of the cabin 6, a simple configured corner joint 7 is provided for interconnecting furniture panels.

The inner wall 61 being formed by furniture panels 51 is coupled to the outer wall 60 by joint pieces 3′, 3. The joint pieces 3′—as shown in FIG. 4—only have a single male connector 31 and are attached to a furniture panel of the outer wall 60. The joint pieces 3—as shown in FIG. 3—include a first and second male connector 31 and are configured to interconnect adjacently positioned furniture panels 101, 102.

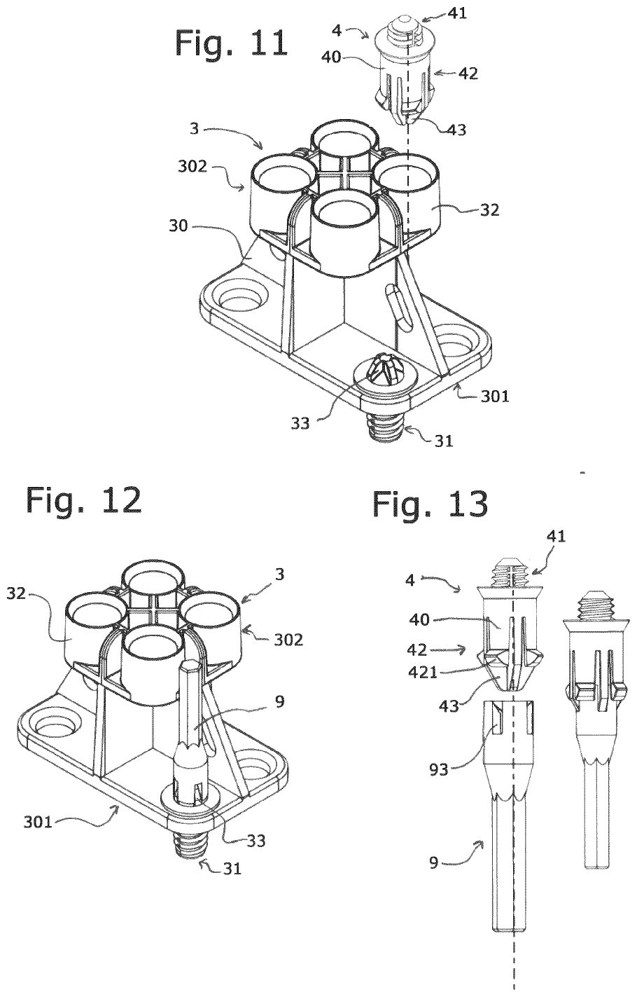

FIG. 11 shows an alternative embodiment of the joint piece 3 and couple item 4. The joint piece 3 is arranged to join furniture panels. At a bottom portion, the joint piece has a base body with an end face 301. The end face is formed by a base plate of the base body. The base plate is spaced from a top portion 302 of the joint piece 3. Here, the top portion 302 has the same configuration as shown in FIG. 1 in which the top portion 302 is provided with at least one female connector 32 for receiving a pin head of a couple item 4. The base plate is provided with at least one through hole, here four through holes, for mounting the joint piece to a furniture panel by at least one male connector 31.

Here, the male connector 31 is a separate item. As shown in FIG. 12, the male connector 31 is a screw type item which can be fastened by a screw tool 9. The male connector 31 has a tool portion 33 to be engaged by the screw tool 9. At an opposite end, the male connector 31 has a threaded portion to be inserted into a thread hole of a furniture panel to fasten the joint piece 3 to the furniture panel.

As further shown in FIG. 13, the couple item 4 is formed by a pin element 40. The couple item 4 has a threaded foot portion 41 for fastening the couple item 4 to a furniture item. The threaded foot portion 41 fits into a thread hole of the furniture item. Herewith, the couple item 4 can be screw mounted to the furniture item. The couple item 4 has a pin head 42 provided with at least one snap-on member 424 snapping the couple item 4 to the joint piece 3. The pin head 42 has a same configuration and functionality as the above disclosed pin head 42 of the couple item 4 as shown in FIG. 3-5.

As shown in FIG. 13, a same screw tool 9 can be used to mount both the male connector 31 and the couple item 4. A same shaped tool portion 33, 43 of respectively the male connector 31 and the couple item 4 allow to use a screw tool 9 with a same shaped tool head 93.

Although the present invention has been described in detail, it will be apparent to those skilled in the art that various changes and modifications can be made without departing from the scope of the invention as hereinafter claimed. It is intended that all such changes and modifications be encompassed within the scope of the present disclosure and claims.

Further, it is remarked that any feature of the system according to the invention which is described in the embodiments and/or mentioned in the dependent claims is in itself considered patentable without any dependency to another presented feature. In particular, any measure presented in a dependent claim is also considered patentable without dependency of the independent claim.

Thus, the invention provides a furniture panel joining system comprising a joint piece for connecting a furniture panel. The joint piece has a base body having a male connector to be inserted into T-slot of a furniture panel. The joint piece has a top portion provided with at least one female connector. The female connector is configured for receiving a male member formed by a pin head of a couple item. This couple item is of benefit for attaching a furniture item which in particular includes a wired electronic unit in a quick manner without a need for a tool or glue to the furniture panel.

### REFERENCE SIGNS LIST

100 furniture panel joining system
101 first furniture panel
102 second furniture panel
110 T-slot
111 keyhole slot
3 joint piece
30 base body
301 end face
302 top portion
31 male connector
310 insert element
311 head portion
312 stem portion
32 female connector
320 aperture
321 first female connector
322 second female connector
323 third female connector
324 fourth female connector
4 couple item
40 pin element
41 foot portion
410 foot stem
411 foot base
42 male member, pin head
420 snap-on member
421 snap finger
5 furniture item
51 inner furniture panel
511 keyhole slot
52 electronic unit
521 actuator
522 sensor
523 speaker
6 cabin system
60 wall; outer wall
61 inner wall
62 inner space
7 corner joint
70 corner joint body
701 corner joint body end face
71 male connector

What is claimed is:

1. A furniture panel joining system for joining a furniture panel, wherein the furniture panel joining system comprises:
a joint piece being configured to connect a furniture panel, wherein the joint piece comprises a base body having at least one end face provided with at least one male connector to connect the joint piece to the furniture panel; and
a furniture panel being configured to receive said male connector of the joint piece,
wherein the furniture panel joining system further comprises a couple item which has a male member to couple a furniture item to the joint piece,
wherein the base body of the joint piece has a top portion provided with at least one female connector formed by an aperture for receiving said male member of said couple item, and
wherein said male member is formed by a cylindrical pin shaped pin element having a pin head which is connectable to the female connector of the joint piece.

2. The furniture panel joining system according to claim 1, wherein the pin head is formed by a snap-on member to be snapped into the aperture of the female connector of the joint piece. 3 The furniture panel joining system according to claim 2, wherein the snap-on member has at least one snap finger for snapping the couple item to the female connector of the joint piece.

4. The furniture panel joining system according to claim 1, wherein the couple item has a foot portion which is connectable to a T-slot of a furniture item.

5. The furniture panel joining system according to claim 1, wherein the couple item has a threaded foot portion being screwable into a thread hole of a furniture item.

6. The furniture panel joining system for joining a furniture panel according to claim 1, wherein
the at least one male connector for connecting the furniture panel is formed by an insert element including a head portion which forms an enlargement on top of a stem portion; and
the furniture panel is provided with a T-slot for receiving said male connector of the joint piece.

7. The furniture panel joining system according to claim 6, wherein the foot portion of the couple item is sized in correspondence with the male connector of the joint piece to allow the furniture panel joining system to be manufactured by providing the same sized T-slots in both the furniture panel and in the furniture item.

8. The furniture panel joining system according to claim 1, wherein the couple item is integrally formed with the furniture item.

9. The furniture panel joining system for joining a furniture panel according to claim 1, wherein the at least one male connector for connecting the furniture panel is formed by an insert element including a threaded portion and the furniture panel is provided with a thread hole for receiving said threaded portion of the male connector of the joint piece.

10. The furniture panel joining system according to claim 1, wherein the base body has a single end face provided with the first and second male connector for interconnecting side by side positioned furniture panels.

11. The furniture panel joining system according to claim 1, wherein the base body has a first end face provided with the first male connector and a second end face provided with the second male connector, wherein the first and second end face are inclined to each other for interconnecting angled positioned furniture panels.

12. The furniture panel joining system according to claim 1, wherein the base body has a truncated shape, wherein in particular, a cross section of the base body is cross-shaped.

13. The furniture panel joining system according to claim 1, wherein the top portion of the base body includes a first and second female connector.

14. The furniture panel joining system according to claim 13, wherein the top portion of the base body includes a third and fourth female connector.

15. The furniture panel joining system according to claim 1, wherein the furniture panel has a T-slot formed by a keyhole slot being formed by an undercut recess having an entry hole being spaced apart from a panel edge of the furniture panel.

16. The furniture panel joining system according to claim 1, wherein the furniture item comprises an inner furniture panel.

17. The furniture panel joining system according to claim 16, wherein the inner furniture panel has a rectangular shape, wherein each corner is provided with a keyhole slot.

18. The furniture panel joining system according to claim 17, wherein each keyhole slot is diagonally directed.

19. The furniture panel joining system according to claim 18, wherein each keyhole slot has an entry hole for receiving a foot portion of the couple item, wherein the entry hole is positioned at an end of the keyhole slot away from a corner of the inner furniture panel.

20. The furniture panel joining system according to claim 1, wherein the furniture panel joining system forms a wall system including at least one side wall mountable by joining adjacently positioned furniture panels by the joint piece, wherein at least one furniture item is couplable to at least one of the joint pieces by the couple item.

21. The furniture panel joining system according to claim 20, wherein the furniture panel joining system is a cabin system.

22. A joint piece for establishing a quick connection of a furniture item, wherein the joint piece comprises a base body having at least one end face provided with at least one of a first and a second male connector, wherein the base body has a top portion provided with at least one female connector formed by an aperture for receiving a pin head which forms a male member of a couple item.

23. The joint piece according to claim 22, wherein the at least one male connector includes a head portion which forms an enlargement on top of a stem portion for an insertion into a T-slot of a furniture panel.

24. The joint piece according to claim 22, wherein the at least one male connector for connecting the furniture panel is formed by an insert element including a threaded portion and a complementary furniture panel is provided with a thread hole for receiving said threaded portion of the male connector of the joint piece.

25. A couple item for establishing a quick connection of a furniture item to a joint piece which joint piece has a base portion being configured to be connected to a furniture panel, wherein the couple item is formed by a cylindrical pin shaped pin element with a pin head forming a male member being connectable to a female connector of the joint piece.

26. A method for connecting a furniture panel and/or for connecting a furniture item thereto, which method comprises the steps of:
providing a furniture panel joining system according to claim 1 including a joint piece and a first furniture panel;
connecting the joint piece to the furniture panel by inserting a first male connector of the joint piece into an aperture of the furniture panel;
providing a furniture item and at least one couple item for attaching the furniture item to the furniture panel; and
inserting the at least one couple item into a female connector of the joint piece to connect the furniture item to the furniture panel.

27. The method according to claim 26, wherein the at least one couple item is a separate item, wherein in a step of the method, the couple item is attached to the furniture item.

28. The method according to claim 27, wherein the at least one couple item is attached by inserting and shifting a foot portion of the couple item into a T-slot or by screwing a threaded food portion of the couple item into a thread hole of the furniture item.
